(19) United States
(12) Patent Application Publication
(10) Pub. No.: US 2003/0041496 A1
(43) Pub. Date: Mar. 6, 2003

(54) Merchandising display and related methods

(75) Inventors: James Edwin Hagen, Bay Village, OH (US); Jeffrey Eric Hacias, Cincinnati, OH (US); Khloe Snell Broelmann, Cincinnati, OH (US); Douwe Eric Bergsma, Cincinnati, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/126,078

(22) Filed: Apr. 19, 2002

Related U.S. Application Data
(60) Provisional application No. 60/286,780, filed on Apr. 25, 2001.

(51) Int. Cl. G09F 3/18

(52) U.S. Cl. 40/661.03

(57) ABSTRACT

A point of purchase merchandising display for use in a retail environment in association with a plurality of products where the products are stored on a plurality of shelves, the display includes fixtures for displaying information that identifies different categories of products and provides information that instructs a consumer on how to use a category of product to achieve a desired benefit and suggests to a consumer the satisfaction that may be enjoyed in achieving the desired benefit. Methods for increasing consumer dwell time in a retail aisle using the described fixtures and displays are provided. Likewise methods for promoting regime usage of two or more fabric care products are also provided.

### CROSS REFERENCE TO RELATED APPLICATIONS

This application claims priority under 35 U.S.C. § 119(e) to U.S. Provisional Application Serial No. 60/286,780, filed Apr. 25, 2001 (Attorney Docket No.8532P).

### BACKGROUND OF THE INVENTION

1. Field of the Invention

The field of the present invention concerns merchandising displays and methods that are used at the point of purchase in the sense that they are used within the retail environment of a retail, wholesale, discount or club store. These displays and methods are applicable and would benefit any retail aisle in which they might be used but are described hereinafter within the context of the “laundry aisle” where detergents, bleaches, pretreaters, fabric conditioners, dry cleaning products and the like are sold.

2. Description of the Prior Art

The use of point of sale and point of purchase displays are well known in the art. Most consumers are very familiar with the racks and displays of products, magazines and other impulse items that are typically crowded together immediately adjacent the cashier or check out location in a store. The displays and methods of the present invention are different in that they are intended for use within the store, in and about the aisles of the store where products are temporarily stocked or stored for sale.

A standard store aisle comprises an elongated walkway that is bordered with shelves on either side that extend from the floor to a height of roughly six to nine feet. Typically, the aisle will contain several groups of generally related products. In many cases, there are so many products in these general groups that an aisle may contain only one or two groups of related products such as aisles dedicated to pet foods and pet care products, household cleaners, household paper products, breads, canned fruits and vegetables, health care and hygiene products, beverages, laundry and fabric care products and others. The signs indicating the group or groups of products that are located on a given aisle are commonly suspended from the ceiling so that they do not take up space in the aisle and they may be seen from a distance. Because the amount of space in the aisle is finite, store operators are reluctant to place anything in the aisle that would cause them to remove product(s) from the aisle.

It is also believed to well known that generally providing information at the point of sale of the product raises the consumer's understanding of the product and its use, and thereby raises the probability that the consumer will purchase products. This is particularly common with electronic and so-called “high tech” products whose operation and capabilities are not well understood by the typical consumer. With such products it is commonplace to provide point of sale information through displays, brochures and/or sales personnel who can aid the consumer in deciding to purchase products.

Detailed information is not generally provided concerning the use and benefits of “low tech” products. Recognizing that there are real costs associated with providing product information at the point of sale, it is believed that store operators will not provided such information where the consumer does not seek it out and where there is no consumer expectation that such information will be provided. In the case of consumer products that are either well known by the consumer or that are believed by the consumer to be well known, no additional product information is provided. Most items sold by the common grocer are prime examples of this, including packaged foods, health and beauty care items, vitamins and nutritional supplements, baby and child care products, pet care products, plant care products, and of course, laundry and fabric care products among others.

Further, it is believed that there is an absence of organization within the aisle. Although generally products are typically grouped together on the aisle, no further effort made to further organize or categorize the products so as to simplify the location of the products by the shopper. More specifically, while separation and categorization has been used within the aisle to identify and highlight the products of a particular manufacturer, no effort has been made to categorize all of the products in the aisle according to their function. Such categorization is across manufacturers and aids the consumer in locating particular type of product by distinguishing amongst the different types of products, and prompts the consumer to compare competing products and to consider how different product types might be used in combination.

### SUMMARY OF THE INVENTION

The present invention provides a merchandising display for use in association with a plurality of products that are stored on multiple shelves in a store aisle. The display comprises a plurality of fixtures for displaying information that identifies different categories of products and display means for displaying information that (a) instructs a consumer on how to use a category of product to achieve a desired benefit and (b) suggests to a consumer the satisfaction that may be enjoyed in achieving the desired benefit.

In a further aspect of the present invention, the display means may be used to display information that instructs a consumer on how to use two or more categories of products together to achieve an overall desired benefit.

In yet a further aspect of the present invention, the merchandising display is used in association with consumer products for use in the cleaning, conditioning and/or care of fabrics.

In a process aspect of the present invention a method is provided for increasing the dwell time of consumers in a retail aisle having a plurality of products stored on a plurality of shelves. The method includes that the steps of providing one or more fixtures to identify one or more categories of products and displaying information that instructs a consumer on how to use a category of product to achieve a desired benefit and that suggests to a consumer the satisfaction that may be enjoyed in achieving the desired benefit.

In a further process aspect of the present invention, the information displayed comprises instructions on how to use two or more categories of products together to achieve an overall desired benefit, and in particular where the products are consumer products that are used in the cleaning, conditioning and/or care of fabrics.

### BRIEF DESCRIPTION OF THE DRAWINGS

While the specification concludes with claims particularly pointing out and distinctly claiming the present invention, it is believed the present invention will be better understood from the following description in conjunction with the accompanying drawings in which:

FIG. 1 is a perspective view of a display of the present invention showing exemplary fixtures and display means.

FIG. 2 is a perspective view of the display in FIG. 1, illustrating a plurality of fixtures to categorize the plurality of products.

FIG. 3 is a perspective view of the display in FIG. 1, illustrating alternative display means.

FIG. 4 is a perspective view of the display in FIG. 1, illustrating alternative display means.

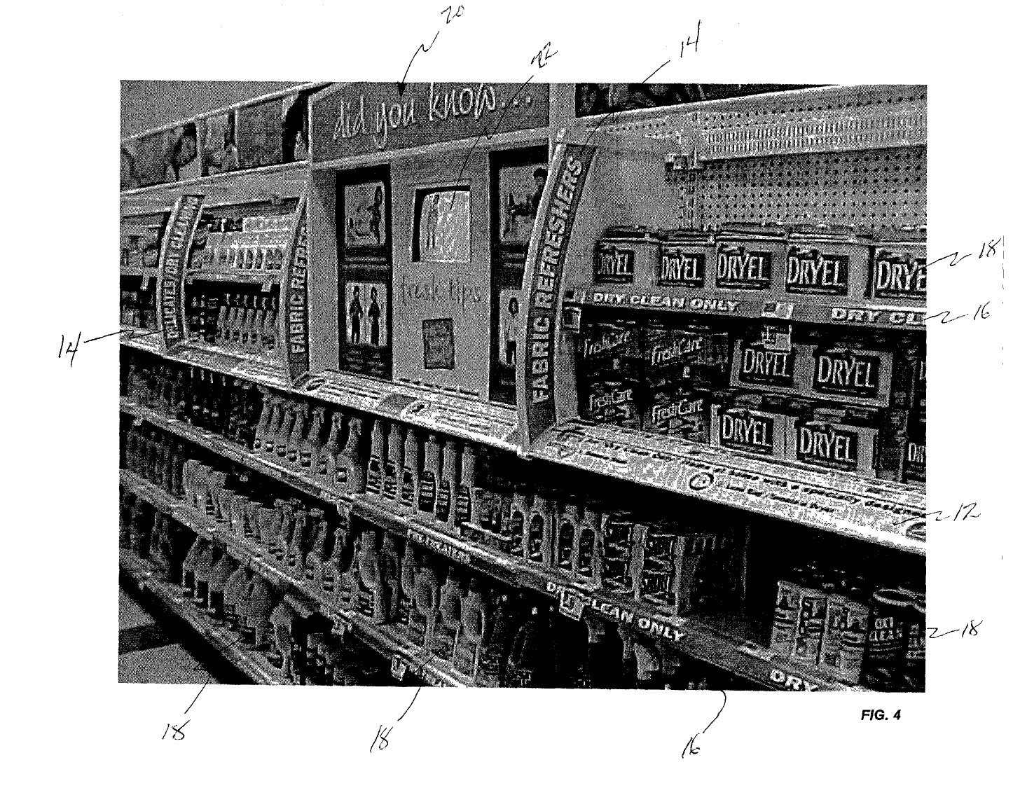

FIG. 5 is a perspective view of a display means of the present invention.

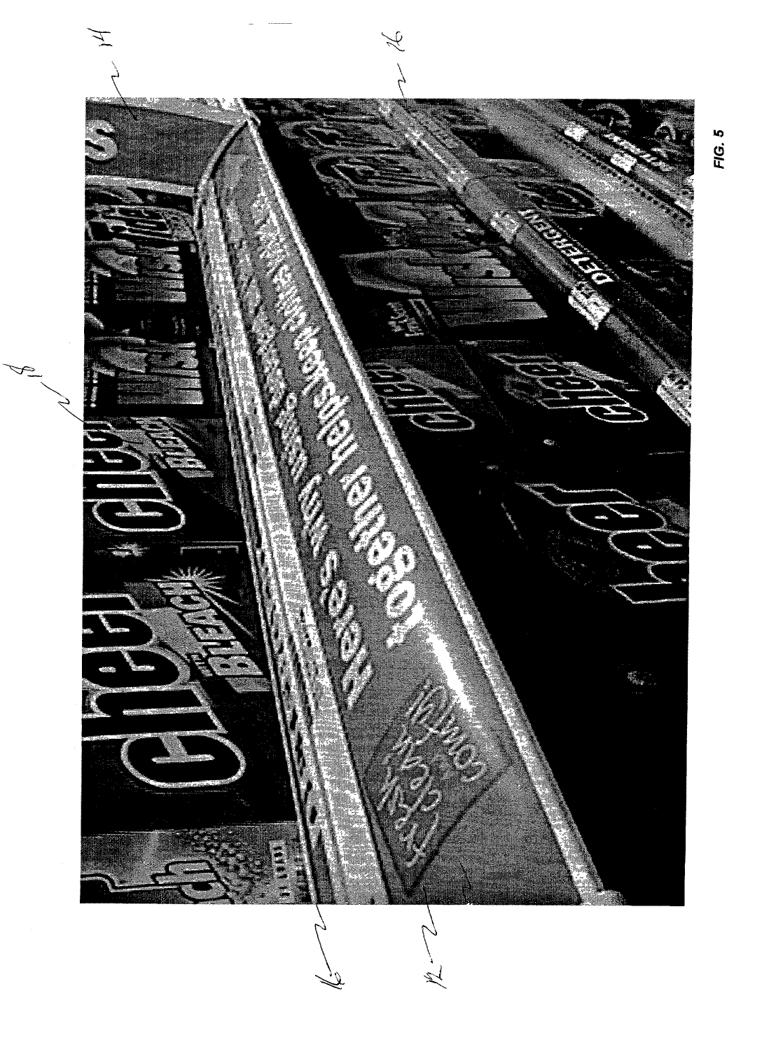

### DETAILED DESCRIPTION OF THE PREFERRED EMBODIMENTS

The present invention comprises fixtures for displaying information that identifies different categories of products and display means for displaying information that (a) instructs a consumer on how to use a given category of product to achieve a desired benefit and (b) indicates to the consumer the satisfaction that may be enjoyed in achieving the desired benefit.

A preferred embodiment of the present invention is shown in the accompanying figures. As specifically shown therein, merchandising display 10 is installed in an aisle having a plurality of horizontally arranged shelves 16 with a plurality of fabric care products 18 stocked thereon. The products 18 are categorized according to their function and fixtures 14 are provided along the aisle to indicate the location of each category of product 18. Several display means 12 are also provided in and about the aisle to present instructions on how to use products 18 to achieve a desired benefit as well as information that suggests or indicates the enjoyment of those benefits.

A. Fixtures

Fixtures 14 are intended to aid the consumer in identifying different types or categories of generally related products. As shown in the accompanying figures, the fixtures are preferably signage affixed to the shelves 16 adjacent products 18. Because of space concerns, fixtures 14 should not be placed where they would obstruct the path of the consumer passing through the aisle. Therefore, it is anticipated that fixtures 14 can also comprise signage affixed to the floor or suspended from the ceiling adjacent products 18.

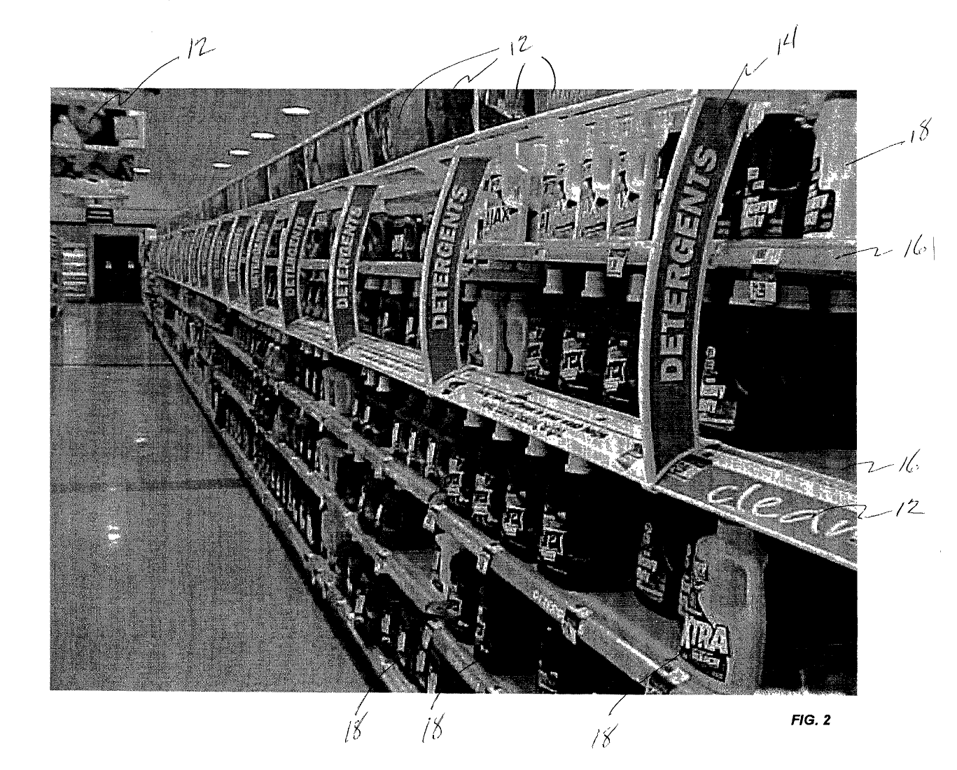

Although it is preferred that fixtures 14 not take up space along the aisle that could otherwise be used to stock product, it is a preferred that the upper shelves of the aisle be recessed to give a more open and inviting appearance to the aisle as a whole. When in this recessed configuration aisle signs or flags may be arranged within this recessed space as shown in FIG. 2.

Fixtures 14 will be made of conventional materials that are known in the art and likewise will be manufactured according to processes that are well known. The fixtures will display information that will designate the type or category of product that is immediately adjacent the fixture. By categorizing products 18 and using fixtures 14 to identify their location within the aisle, the selection of particular products within the aisle is simplified. Further, consumers who are unaware of the functions and benefits derived from the use of unfamiliar products are educated about those other products.

B. Display Means

Display means 12 can take a variety of forms that are intended to provide information to the consumer while they are present in the aisle. A shown in the accompanying figures, display means 12 can be instructional information provided on the shelf face, as well as pictures and posters provided above the shelves and at the terminal ends of the aisle.

Where the upper shelves are preferably recessed as shown in FIG. 2, a sloping or tapered shelf face may be provided for displaying specific instructions to the consumer. Preferably, instructions on how to use a particular type of product or a combination of products will be provided immediately adjacent products 18 on the shelf face. Information and instructions presented on the shelf face are particularly preferred as they are adjacent the product but are readily accessible to the consumer. Such information may be viewed by most consumers and instructions may be provided in braille for visually impaired consumers.

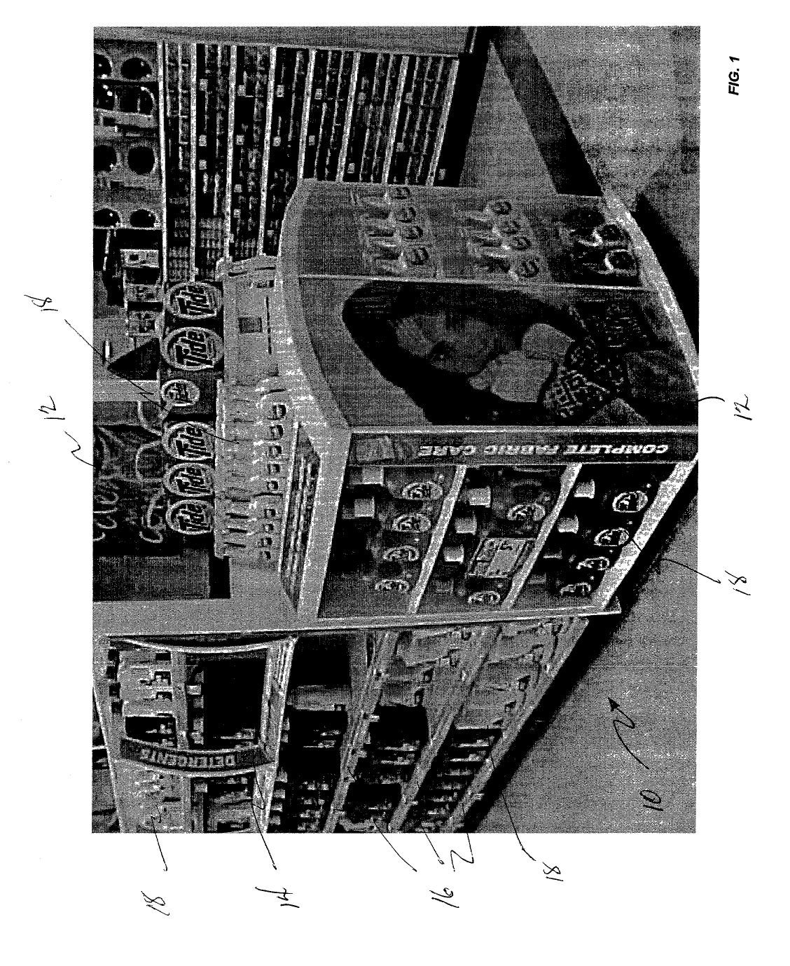

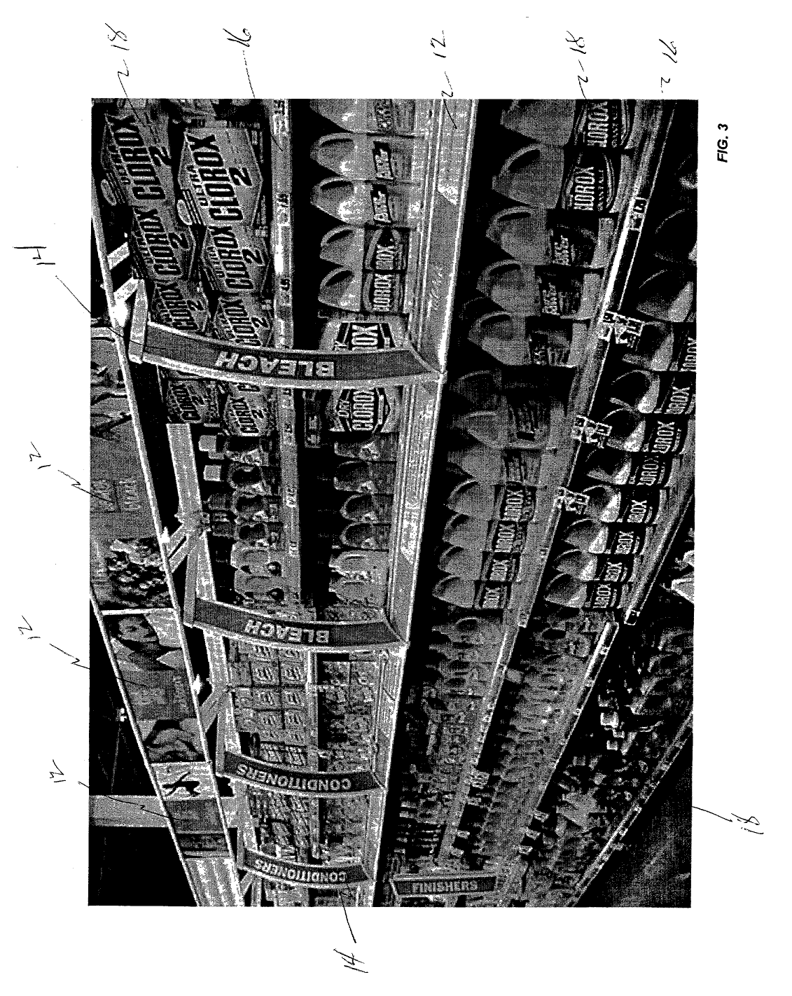

As shown in FIG. 1, display means 12 can consist of photographs and posters located at the terminal ends of an aisle. Likewise, as shown in more detail in FIG. 3, photographs may be presented on fixtures above shelves 16. The use of photographs is particularly useful in presenting information to the consumer concerning the benefits that may be enjoyed from through the effective use of the products.

An additional preferred display means is the use of audio-visual presentations. Specifically, and as shown in 4, an aisle theater 20 having a video terminal 22 and audio capability, not shown, may be installed to present more detailed information concerning the use and benefits of various types of products that are present in the aisle. The use of pre-recorded audio-visual presentations are particularly useful because of the amount of detailed information that may be provided in a short period of time and the flexibility to present a variety of presentations. It is anticipated that the audio-visual presentation will be pre-recorded, but it may also be interactive. As such, it is anticipated that terminal 22 will be linked with a computer that may be accessed by the consumer to provide an interactive presentation. Although it is anticipated that live presentations may also be used as display means 12, live presentations should be in addition to and not in place of fixed display means.

The specific types of information that are to be presented to the consumer are described in detail in the following section.

C. Information Displayed Provided by Display Means

Display means 12 are used to display at least two types of information to the consumer. The first is information on how to use a product and how to obtain the desired result from that product. In addition, the merchandising display of the present invention will also include display means 12 that indicate or suggest the satisfaction that will be enjoyed when the desired result is achieved.

1. Instructions For Achieving Desired Result/Benefit

The information to be provided on display means 12 is information concerning the use of products 18. For instance, in the case of the laundry aisle, information concerning how to use pre-treaters, detergents, fabric conditioners, dry clean only-fabric products, fabric refreshers, wrinkle control products and other fabric care products is to be provided. Such information is not limited to product information and the specific steps by which is it is applied or used to treat fabrics. Rather, such information will also include steps and procedures that may be used to improve the effectiveness of the result when using a given type of product. Alternatively, such instructional information may comprise instructions unrelated to the designed use of the product. Further, such information will preferably instruct the consumer on how to obtainer desirable benefits from using two or more different types of products in combination with each other.

Preferably, the information provided by the display means of the present invention will include one or more informational statements selected from the group consisting of:

Wash children's soft toys frequently to help wash away the allergens that frequent them;

Don't overload your washer. Overloading your washer can cause poor cleaning;

Separate heavily soiled clothes from the rest of your laundry. Heavily soiled laundry requires more detergent;

Don't overstuff your washing machine! This leads to suds residues on clothes which means more re-washing and re-rinsing;

After you measure enough liquid detergent for a load of laundry, pour some of the liquid right from the cap on stains in the load for quick and cost effective pretreating;

For high efficiency washing machines, be sure to use a detergent specially made for low water volumes. Regular detergents can oversuds and may not provide the same level of cleaning in these machines;

Using liquid fabric softener with your detergent reduces friction in the washer, and reduces wear and tear;

Using detergent and softener together reduces wear and tear in your washer, keeping clothes looking newer, longer;

Using fabric softener in your washer helps keep colors looking bright;

Liquid fabric softeners help reduce wrinkles;

Put a dryer sheet in your linen closet and close the door on odor;

Put a dryer sheet in your shoes and give odors the boot;

Put a dryer sheet in wastebaskets and toss out odor;

Put a dryer sheet in your gym bag and keep it from smelling like your just worked out;

Put a dryer sheet in your luggage and keep odors from traveling;

Store dryer sheets in a cool, dry area. Storing them on the dryer or near a heater can cause them to stick together, making them difficult to use;

Use fabric refreshers on fabrics so odor won't hang around when your pet does;

Spray fabric refresher on pillows and say goodnight to odor;

Use fabric refresher on smoke fabrics and “poof” odors disappear;

Spray fabric refresher in your care and make it smell like a ride in the country;

Use fabric refresher on garments that you don't want to launder often like sweaters and jackets, but that can pick up smells before they are dirty and need to be laundered;

Caring for Dry Clean Only items at home with a specially designed kit is as easy as: 1. Remove stain 2. Load Bag./Tumble in Dryer 3. Hang Garments;

Add a little bleach to the water, and fresh cut flowers stay fresh longer;

Wash dish towels in a sanitizing bleach, and stop E Coli and Salmonella;

There's a bleach to brighten whites and a bleach to brighten colors;

Avoid bleach accidents that can ruin good clothes—look for thicker formulas that minimize staining;

Keep an extra pretreater in the kitchen and near the hamper because the sooner you treat a stain, the more likely it will come out;

Starches contain a silicone ironing aid to make ironing quicker and easier—in addition to making shirts and blouses look sharp and crisp;

Always use cold water rinse. It is just as effective as warm water rinse, AND it saves energy (and money on your utility bills!);

Wash shower curtain to prevent mildew;

The preceding statements are also the subject of copyright owned by The Procter & Gamble Company,® 2000.

2. Satisfaction/Enjoyment of Benefits

The information displayed on the display means of the present invention further includes information that indicates or suggests to the consumer the satisfaction or enjoyment that the consumer will derive from the benefits gained using the products in the aisle. In the case of the laundry aisle, consumers commonly indicate that the laundering of clothes and other household fabrics is a chore and that little satisfaction or enjoyment is derived from performing this chore. Therefore, it is intended that the display means will also indicate to the consumer how good they and their family members will look when using the products in the aisle. Thus, the display means provides information that serves to indicate the rewards or satisfaction that the consumer will enjoy after using the products.

D. Methods

1. Methods for Increasing Consumer Dwell Time

It has been found that the installation of the merchandising display of the present invention or the providing of fixtures and display means of the present invention can serve to increase the dwell time of consumers in the aisle where the display is located. More specifically, dwell time is a measure of the amount of time that a consumer spends in a given aisle. It may be measured manually by observing the consumers as they pass through the aisle, or more preferably, it may be measured by using an electronic tracking system that tracks the consumers' route through a given store, recording the path and the length of time at each location.

The method of increasing dwell times includes the steps of providing one or more fixtures to identify one or more categories of products and displaying information that instructs a consumer on how to use a category of product to achieve a desired benefit and that suggests to a consumer the satisfaction that may be enjoyed in achieving the desired benefit. As noted above, the products sold in association with the display of the present invention are first categorized according to their function. In the case of laundry and fabric care products, this categorization will follow detergents or cleaners, bleaches, fabric conditioners, fabric refreshers, wrinkle control products, etc.

The methods of the present invention preferably use the fixtures and display means described hereinabove. The information displayed will preferably comprise instructions concerning the use of a product and a photograph of a consumer enjoying the benefit provided by a product. As noted above, the display means may comprise printed matter, an audio-visual presentation, or a live presentation or demonstration. Alternatively, where the merchandising display of the present invention is configured for use in the laundry aisle, the display means may comprise a fabric sample that has been treated with one or more of the cleaning, conditioning and/or fabric care products to demonstrate a desirable result of that treatment.

Using an electronic tracking system, the average dwell time of consumers in the laundry aisle of a test store was measured before the installation of the display and then at one, two and three months after that installation. The increases in dwell time are tabulated in the following table.

Effect of Merchandising Display on Dwell Time

| | Minutes | Percentage Increase |
|---|---|---|
| Before Display Installation | 1.59 | — |
| 1 month after Installation | 1.79 | 13% |
| 2 months after Installation | 1.84 | 16% |
| 3 months after Installation | 2.17 | 37% |

Consumer “dwell” time progressively increased through out the test period. The results for three months following installation show that “dwell” times increased to 2.17 minutes (+37%) from 1.59 minutes in the pretest period. All other factors were held constant with the only material change to the store environment was the installation of the display of the present invention. The increase in dwell time is a reflection of a change in the consumer's behavior brought about the display of the present invention.

2. Methods for Promoting Regimen Usage

It has been found that the installation of the merchandising display of the present invention or the providing of fixtures and display means of the present invention also serves to promote the regimen usage of two or more consumer products for use in the cleaning, conditioning and/or care of fabrics. As used herein “regimen usage” is the use of two or more products together or in series on a given load of fabrics to obtain a desired result. As suggested by the information described above for display on the display means, there are many benefits that may be derived from the combined use of detergents and fabric conditions that are not well known by consumers. Thus, the presentation of information concerning regimen usage and the benefits that may be obtained tend to promote the regimen usage.

The methods for promoting regimen usage of two or more consumer products for use in the cleaning, conditioning and/or care of fabrics includes the steps of providing one or more fixtures to categorize two or more of the consumer products, said products categorized according to their function and displaying information that instructs a consumer on how to use two or more categories of products together to achieve a desired fabric care benefit and that suggests to a consumer the satisfaction that may be enjoyed in achieving the desired benefit. The fixtures and display means described above are preferred for use in these methods.

Sales figures from stores where the display of the present invention has been installed were compared with other stores where no installation was made. The figures indicated that the installation increased sales of products in all categories and that sales in collateral products such as fabric softeners, pretreaters etc. increased more than sales of detergents. This indicates that the display persuaded consumers to purchase non-detergent products for use in combination with detergent.

While particular embodiments of the present invention have been illustrated and described, it will be obvious to those skilled in the art that various changes and modifications can be made without departing from the spirit and scope of the invention, and it is intended to cover in the appended claims all such modifications that are within the scope of this invention.

What is claimed is:

1. A merchandising display for use in a retail environment in association with a plurality of products where the products are stored on a plurality of shelves, the display comprising:
a plurality of fixtures for displaying information that identifies different categories of products; and
display means for displaying information that instructs a consumer on how to use a category of product to achieve a desired benefit and that suggests to a consumer the satisfaction that may be enjoyed in achieving the desired benefit.

2. The merchandising display of claim 1, wherein the fixtures identify products based on product function.

3. The merchandising display of claim 1, wherein the display means displays information that instructs a consumer on how to use two or more categories of products together to achieve a desired benefit.

4. The merchandising display of claim 1, wherein the display means is signage affixed to a shelf adjacent to the category of product that is the subject of the displayed information.

5. The merchandising display of claim 1, wherein the fixture is signage within 2 meters, preferably within 1 meters and more preferably within 0.5 meters of the category of product that is the subject of the displayed information.

6. The merchandising display of claim 1, wherein the fixture is signage affixed to a shelf adjacent to the category of product that is the subject of the displayed information.

7. The merchandising display of claim 1, wherein the fixture is signage within 2 meters, preferably within 1 meters and more preferably within 0.5 meters of the category of product that is the subject of the displayed information.

8. The merchandising display of claim 1, wherein the display means comprises a photograph of a consumer enjoying the benefit.

9. The merchandising display of claim 1, wherein the display means comprises an audio-visual presentation.

10. The merchandising display of claim 1, wherein the display means comprises a live presentation.

11. The merchandising display of claim 1, wherein the plurality of products comprise consumer products for use in the cleaning, conditioning and/or care of fabrics.

12. The merchandising display of claim 11, wherein the display means comprises a fabric sample that has been treated with one or more of the cleaning, conditioning and/or fabric care products.

13. A method of increasing consumers dwell time in a retail aisle, the aisle comprising a plurality of products stored on a plurality of shelves, the method comprising the steps of
providing one or more fixtures to identify one or more categories of products; and
displaying information that instructs a consumer on how to use a category of product to achieve a desired benefit and that suggests to a consumer the satisfaction that may be enjoyed in achieving the desired benefit.

14. The method of claim 13, wherein the products are categorized according to their function.

15. The method of claim 13, wherein the displayed information comprises instructions on how to use two or more categories of products together to achieve a desired benefit.

17. The method of claim 13, wherein the displayed information is presented on signage affixed to a shelf adjacent the category of product that is the subject of the instructions.

18. The method of claim 13, wherein the displayed information is presented on signage within 2 meters, preferably within 1 meters and more preferably within 0.5 meters of the category of product that is the subject of the instructions.

19. The method of claim 13, wherein the fixture is signage affixed to a shelf adjacent the category of products.

20. The method of claim 13, wherein the fixture is signage within 2 meters, preferably within 1 meters and more preferably within 0.5 meters of the category of products.

21. The method of claim 13, wherein the displayed information comprises a photograph of a consumer enjoying the benefit.

22. The method of claim 13, wherein the displayed information is presented in an audio-visual presentation.

23. The method of claim 13, wherein the displayed information is presented in a live presentation.

24. The method of claim 13, wherein the plurality of products comprise consumer products for use in the cleaning, conditioning and/or care of fabrics.

25. The method of claim 24, wherein the display means comprises a fabric sample that has been treated with one or more of the cleaning, conditioning and/or fabric care products.

26. A method for promoting the regimen usage of two or more consumer products for use in the cleaning, conditioning and/or care of fabrics, the method comprising the steps of:
providing one or more fixtures to categorize two or more of the consumer products, said products categorized according to their function; and
displaying information that instructs a consumer on how to use two or more categories of products together to achieve a desired fabric care benefit and that suggests to a consumer the satisfaction that may be enjoyed in achieving the desired benefit.
